(19) United States
(12) Patent Application Publication
(10) Pub. No.: US 2010/0302309 A1
(43) Pub. Date: Dec. 2, 2010

(54) Ink Jet Printer

(75) Inventors: Jun HATTA, Nagoya-shi (JP); Tomohisa HIGUCHI, Nagoya-shi (JP); Nobuo HIRAKI, Nagoya-shi (JP); Yoshinori KATO, Nagoya-shi (JP); Shin MANABE, Nagoya-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Aichi (JP)

(21) Appl. No.: 12/474,993

(22) Filed: May 29, 2009

(51) Int. Cl. B41J 2/165; B41J 2/175

(52) U.S. Cl. 347/32; 347/85

(57) ABSTRACT

An ink jet printer may be provided with an ink jet head, a cam member, a cam follower, and a valve operation mechanism. The ink jet head may comprise an ink chamber, an exhaust passage communicating with the ink chamber, and an exhaust valve disposed at the exhaust passage. The cam member may comprise a cam groove. The cam member may be configured to rotate. The cam groove may comprise a first groove, a second groove, and a third groove. The second groove and the third groove may branch from one end of the first groove. The cam follower may be configured to be guided along the cam groove. The valve operation mechanism may be coupled to the cam follower. In a state where the cam follower is present in a predetermined position in the third groove, the valve operation mechanism may make contact with the exhaust valve, and the exhaust valve may be in an opened state.

### BACKGROUND

1. Field

In the present specification, an ink jet printer comprising an ink jet head is taught. In particular, in the present specification, a new mechanism for opening and closing an exhaust valve of the ink jet head is taught.

2. Description of the Related Art

Ink jet printers are taught in U.S. Pat. No. 7,258,420, US Patent Application Publication No. 2005/195246 (Published Patent Application of U.S. Pat. No. 7,452,065), etc. These ink jet printers comprise an ink jet head provided with an exhaust valve, a cam member provided with a cam groove, and a guide member that is guided along the cam groove in the case where the cam member rotates. In the case where the guide member is present in a predetermined position within the cam groove, the guide member makes contact with the exhaust valve, and the exhaust valve is in an opened state. In this state, gas within the ink jet head (for example, bubbles within the ink) can be discharged.

### BRIEF SUMMARY

One of the features taught in the present specification is an ink jet printer. This ink jet printer may comprise an ink jet head, a cam member, a cam follower, and a valve operation member. The ink jet head may comprise an ink chamber, an exhaust passage communicating with the ink chamber, and an exhaust valve disposed at the exhaust passage. The cam member may comprise a cam groove. The cam member may be configured to rotate. The cam groove may comprise a first groove, a second groove, and a third groove. The second groove and the third groove may branch from one end of the first groove. The cam follower may be configured to be guided along the cam groove. The valve operation mechanism may be coupled to the cam follower. In a state where the cam follower is present in a predetermined position in the third groove, the valve operation mechanism may make contact with the exhaust valve, and the exhaust valve may be in an opened state.

### BRIEF DESCRIPTION OF THE DRAWINGS

FIG. 1 shows a schematic configuration of an ink jet printer.

FIG. 2 shows a part of an interior of the ink jet printer.

FIG. 3 shows a schematic configuration of each element related to maintenance.

FIG. 4 shows a state where a cap has risen from the state of FIG. 3.

FIG. 5 shows a state where a slider has moved toward the left from the state of FIG. 4.

FIG. 6 shows a plan view of a cam member.

FIG. 7 shows a plan view of a rotation member.

FIG. 8 shows a block diagram of a controller and each element connected thereto.

FIG. 9 shows how the state of the cam member, etc. changes in the case where the cam member makes one revolution in a state where a stopper is present in an upper position.

FIG. 10 shows how the state of the cam member, etc. changes in the case where the cam member makes one revolution in a state where the stopper is present in a lower position.

FIG. 11 shows a flowchart of processes executed by the controller.

FIG. 12 shows a continuation of the flowchart of FIG. 11.

### DETAILED DESCRIPTION OF THE PREFERRED EMBODIMENT

An ink jet printer of the present embodiment will be described with reference to the figures. Moreover, in the present embodiment, a part of the description of the configuration of the ink jet printer will be omitted. A more detailed description of the configuration of ink jet printers is taught in, for example, U.S. Pat. No. 7,258,420, US Patent Application Publication No. 2005/195246 (Published Patent Application of U.S. Pat. No. 7,452,065), US Patent Application Publication No. 2007/296754, etc. The contents of these documents are incorporated by reference into the present specification.

### (Overall Configuration of Ink Jet Printer)

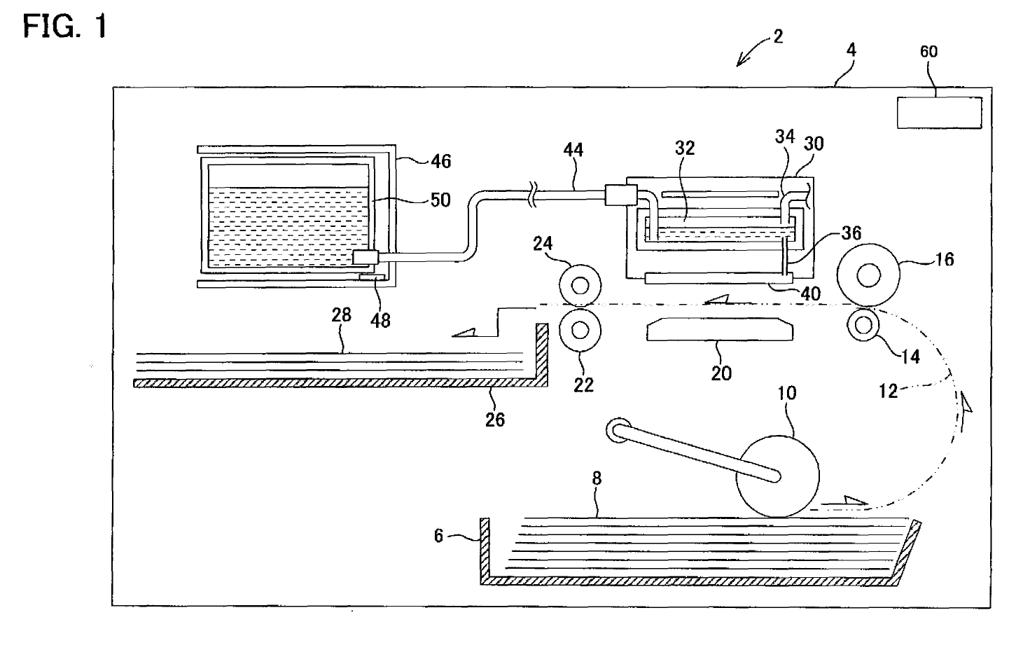

FIG. 1 shows an ink jet printer 2 of the present embodiment. The ink jet printer 2 comprises a casing 4, a first tray 6, a second tray 26, and a feed path 12. The casing 4 houses the elements 6, 12, 26, etc. The first tray 6 houses a print medium 8 that is yet to be printed. The print medium 8 is fed along the feed path 12 to the second tray 26. An image is formed (printed) on the print medium 8 during the feeding process. The second tray 26 houses a print medium 28 that has been printed.

The ink jet printer 2 further comprises a feed roller 10, a pair of rollers 14 and 16, and a pair of rollers 22 and 24. The feed roller 10 sends the print medium 8 within the first tray 6 toward the pair of rollers 14 and 16 (toward the upper right in FIG. 1). The print medium 8 thereby enters between the pair of rollers 14 and 16. The pair of rollers 14 and 16 feed the print medium 8 toward the pair of rollers 22 and 24 (toward the left in FIG. 1). As a result, the print medium 8 enters between the pair of rollers 22 and 24. An image is formed on the print medium 8 between the pair of rollers 14 and 16 and the pair of rollers 22 and 24, thus forming the printed print medium 28. The pair of rollers 22 and 24 feed the printed print medium 28 to the second tray 26.

The ink jet printer 2 further comprises a platen 20 and an ink jet head 30. The platen 20 and the ink jet head 30 are disposed between the pair of rollers 14 and 16 and the pair of rollers 22 and 24. The platen 20 is disposed below the ink jet head 30. The print medium 8 passes between the platen 20 and the ink jet head 30. At this juncture, the ink jet head 30 forms an image on the print medium 8. Note that the configuration of the ink jet head 30 will be described later in detail.

The ink jet printer 2 further comprises a cartridge housing part 46 and an ink fetching path 44. The cartridge housing part 46 houses an ink cartridge 50. The ink cartridge 50 houses ink. The ink cartridge 50 is connected with one end of the ink fetching path 44. The other end of the ink fetching path 44 communicates with the ink jet head 30. The ink within the ink cartridge 50 is sent to the ink jet head 30 via the ink fetching path 44. Moreover, although only one ink cartridge 50 is shown in FIG. 1, the ink jet printer 2 may be provided with a plurality of ink cartridges (that is, a plurality of colors of ink may be utilized).

Moreover, the ink jet printer 2 further comprises a cartridge sensor 48 and a controller 60. The cartridge sensor 48 is connected to the controller 60. In a state where the ink cartridge 50 is housed in the cartridge housing part 46, the cartridge sensor 48 sends a first signal (for example, a high signal) to the controller 60. Alternatively, in a state where the ink cartridge 50 is not housed in the cartridge housing part 46, the cartridge sensor 48 sends a second signal (for example, a low signal) to the controller 60.

### (Configuration of Ink Jet Head)

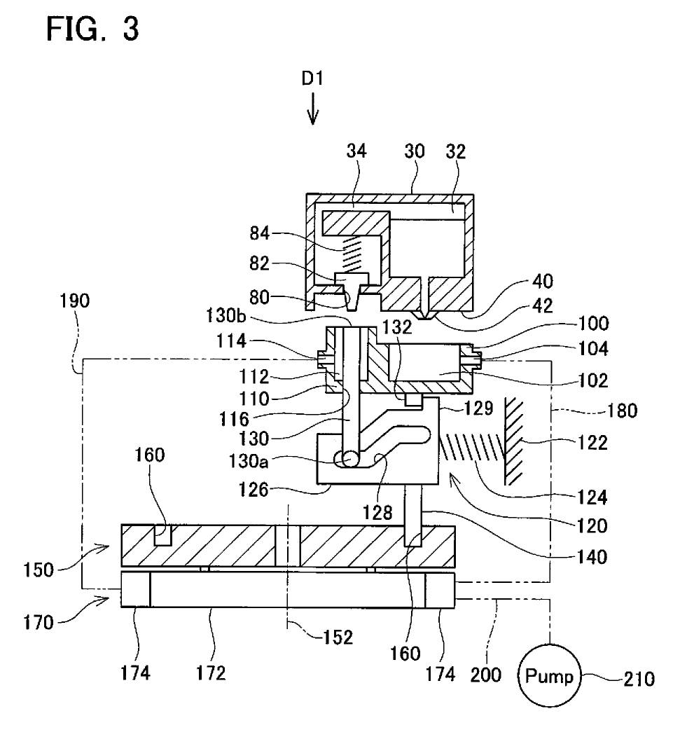

The ink jet head 30 comprises an ink chamber 32, an exhaust passage 34, an ink passage 36, a nozzle surface 40, etc. The ink chamber 32 communicates with the ink fetching path 44. Ink within the ink cartridge 50 is sent to the ink chamber 32 via the ink fetching path 44. One end of the exhaust passage 34 communicates with the ink chamber 32. The other end side of the exhaust passage 34 is not shown in FIG. 1. The configuration of the other end side of the exhaust passage 34 will be described in detail later. One end of the ink passage 36 communicates with the ink chamber 32. A nozzle 42 (not shown in FIG. 1, but shown in FIG. 3) is formed at the other end of the ink passage 36. A plurality of nozzles 42 is formed in the nozzle surface 40.

### (Configuration of Carriage)

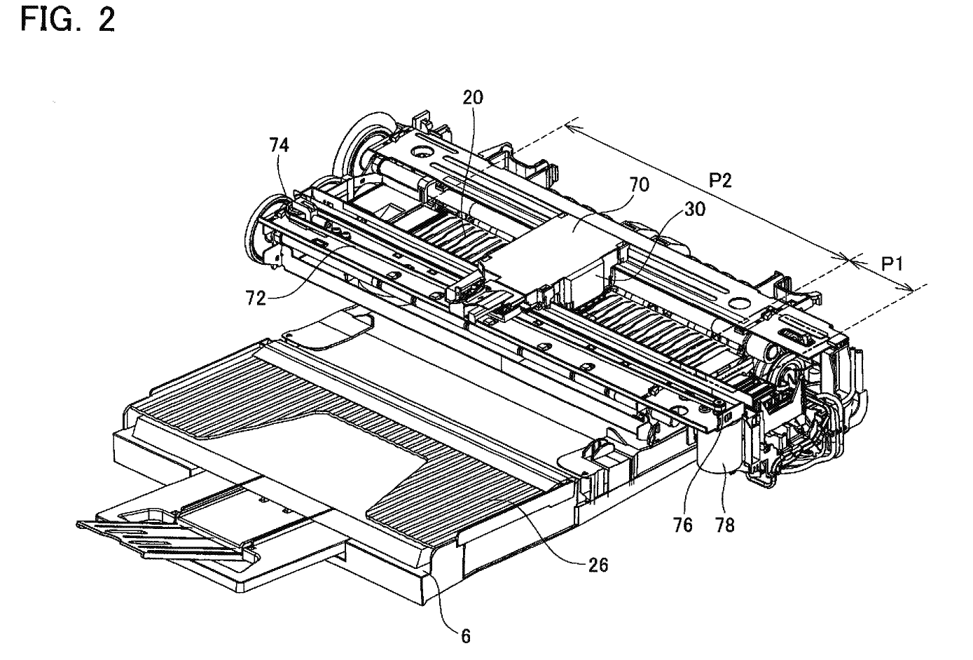

FIG. 2 shows the configuration of the interior of the ink jet printer 2. The ink jet printer 2 further comprises a carriage 70, a belt 72, a pair of pulleys 74 and 76, and a carriage motor 78. The ink jet head 30 is mounted on the carriage 70. The carriage 70 is connected to the belt 72. The belt 72 is suspended between the pair of pulleys 74 and 76. The carriage motor 78 is connected to the pulley 76.

When the carriage motor 78 is driven, the pulley 76 rotates. When the pulley 76 rotates, the belt 72 and the pulley 74 rotate. The carriage 70 connected to the belt 72 thereby moves. The carriage 70 moves in the direction in which the belt 72 is suspended between the pair of pulleys 74 and 76 (a direction perpendicular to the plane of the paper in FIG. 1). The movement of the carriage 70 moves the ink jet head 30. The range shown by the arrow P2 is the range in which the platen 20 is present. That is, the range shown by the arrow P2 is the range through which the print medium 8 passes. In a state where the carriage 70 is present in the range shown by the arrow P2, the ink jet head 30 is facing the print medium 8 (see FIG. 1). In this state, the ink jet head 30 discharges ink from the nozzles 42, and is capable of forming an image on the print medium 8. By contrast, the range shown by the arrow P1 is a range through which the print medium 8 does not pass. In a state where the carriage 70 is present in the range shown by the arrow P1, maintenance as described later is executed on the ink jet head 30. Below, the range shown by the arrow P1 is termed a waiting position, and the range shown by the arrow P2 is termed a printing position.

### (Configuration Related to Maintenance)

FIG. 3 shows a schematic configuration of the ink jet head 30 and elements for executing maintenance (e.g., a purge process, an exhaust process, etc.; described later) on the ink jet head 30. As described above, the ink jet head 30 comprises the exhaust passage 34 that communicates with the ink chamber 32. The ink jet head 30 further comprises an exhaust opening 80, an exhaust valve 82, and a spring 84. The exhaust opening 80 opens to the exterior of the ink jet head 30. The exhaust passage 34 communicates with the exhaust opening 80. The exhaust valve 82 is inserted into the exhaust opening 80. The spring 84 applies force in a direction for closing the exhaust valve 82 (downward force in the present embodiment) to the exhaust valve 82. More specifically, the spring 84 applies force to the exhaust valve 82 in a direction for closing the exhaust opening 80 (that is, a direction for closing the exhaust passage 34) such that the exhaust valve 82 enters the exhaust opening 80. As a result, the exhaust valve 82 assumes a closed state in the case where external force other than from the spring 84 is applied to the exhaust valve 82. That is, the exhaust passage 34 assumes a closed state.

The ink jet printer 2 further comprises various elements 100, 110, 120, 150, 170, etc. related to maintenance of the ink jet head 30. These elements 100, 110, 120, 150, 170, etc. are present below the ink jet head 30 that is present in the waiting position P1 (see FIG. 2).

### (Configuration of Cap)

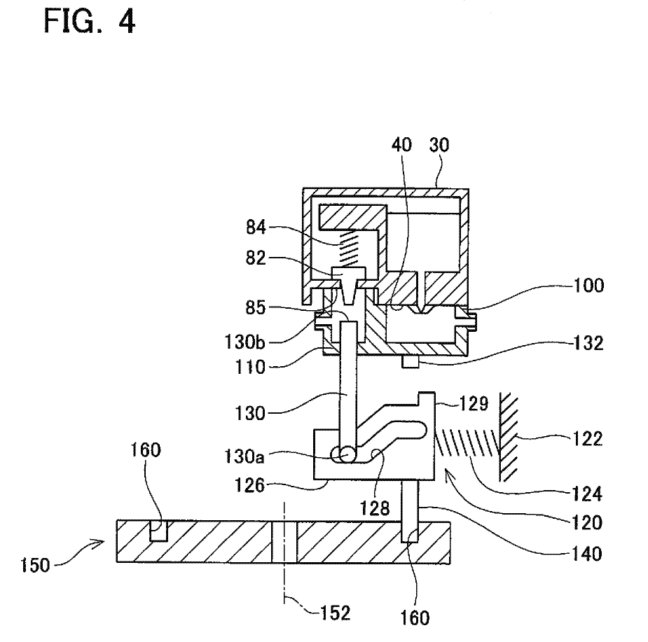

The ink jet printer 2 comprises a nozzle cap 100 and an exhaust cap 110. The nozzle cap 100 and the exhaust cap 110 are configured integrally. However, the nozzle cap 100 and the exhaust cap 110 may be configured separately in another embodiment. The nozzle cap 100 and the exhaust cap 110 can be moved between an upper position and a lower position. FIG. 3 shows a state where the caps 100 and 110 are present in the lower position. FIG. 4 shows a state where the caps 100 and 110 are present in the upper position.

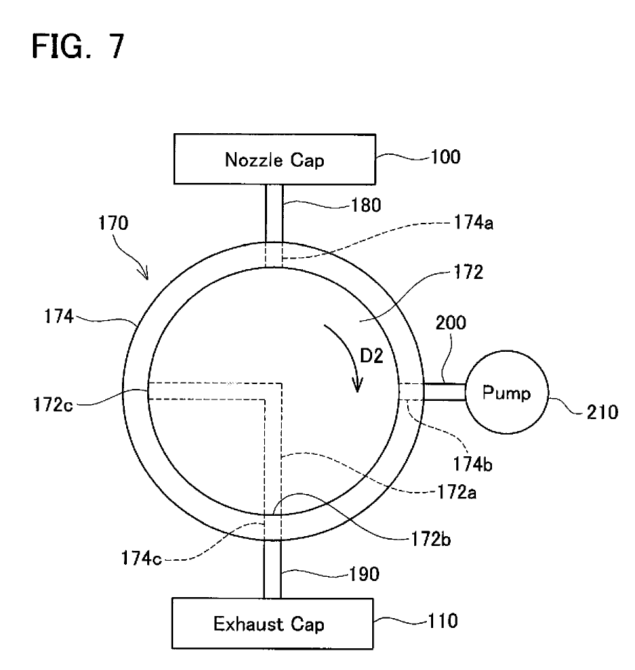

In a state where the nozzle cap 100 is present in the lower position (the state of FIG. 4), the nozzle cap 100 does not make contact with the nozzle surface 40 of the ink jet head 30. In a state where the nozzle cap 100 is present in the upper position (the state of FIG. 3), the nozzle cap 100 makes contact with the nozzle surface 40 in which the nozzles 42 are formed. That is, in the state where the nozzle cap 100 is present in the upper position, the nozzle cap 100 caps the nozzle surface 40. Further, in other words, in the state where the nozzle cap 100 is present in the upper position, the nozzle cap 100 caps the nozzles 42. The nozzle cap 100 comprises an opening 104. The opening 104 communicates with one end of a first passage 180. A space 102 within the nozzle cap 100 communicates with the first passage 180 via the opening 104. The other end of the first passage 180 is capable of communicating with a gas passage 172a of a rotation member 170 described later (see FIG. 7).

In a state where the exhaust cap 110 is present in the lower position (the state of FIG. 4), the exhaust cap 110 does not make contact with a lower surface 85 (see FIG. 4) onto which the exhaust opening 80 of the ink jet head 30 opens. In a state where the exhaust cap 110 is present in the upper position (the state of FIG. 3), the exhaust cap 110 makes contact with the lower surface 85. That is, in the state where the exhaust cap 110 is present in the upper position, the exhaust cap 110 caps the lower surface 85. Further, in other words, in the state where the exhaust cap 110 is present in the upper position, the exhaust cap 110 caps the exhaust opening 80. Further, in other words, in the state where the exhaust cap 110 is present in the upper position, the exhaust cap 110 caps the exhaust valve 82. The exhaust cap 110 comprises an opening 114. The opening 114 communicates with one end of a second passage 190. Space 112 within the exhaust cap 110 communicates with the second passage 190 via the opening 114. The other end of the second passage 190 is capable of communicating with the gas passage 172a of the rotation member 170 described later (see FIG. 7).

### (Configuration of Valve Operation Mechanism)

The ink jet printer 2 comprises a valve operation mechanism 120. The valve operation mechanism 120 comprises a spring support member 122, a spring 124, a slider 126, a shaft 130, and a stopper 132. The spring support member 122 is fixed to a side of the casing 4 (see FIG. 1), and thus does not move. The spring support member 122 supports one end of the spring 124. The other end of the spring 124 is connected to the slider 126. That is, the spring 124 is disposed between the spring support member 122 and the slider 126. The spring 124 applies force (in the present embodiment, force in the leftward direction of FIG. 3) to the slider 126 such that the slider 126 approaches a rotation center 152 of a cam member 150 described later.

The slider 126 comprises a guide groove 128 and a protrusion 129. The guide groove 128 is a cross-sectionally U-shaped groove that has a guide surface for guiding a lower end 130a of the shaft 130 described later. Moreover, the guide groove 128 may equally well be a slit (a through hole) that has a guide surface for guiding the lower end 130a of the shaft 130 described later. A portion at one side of the guide groove 128 in a horizontal direction (in the present embodiment, the portion at the right side in FIG. 3) is formed in a higher position than the other side of the guide groove 128 in the horizontal direction (in the present embodiment, the portion at the left side in FIG. 3). The protrusion 129 protrudes upward more than the remaining portion of the slider 126.

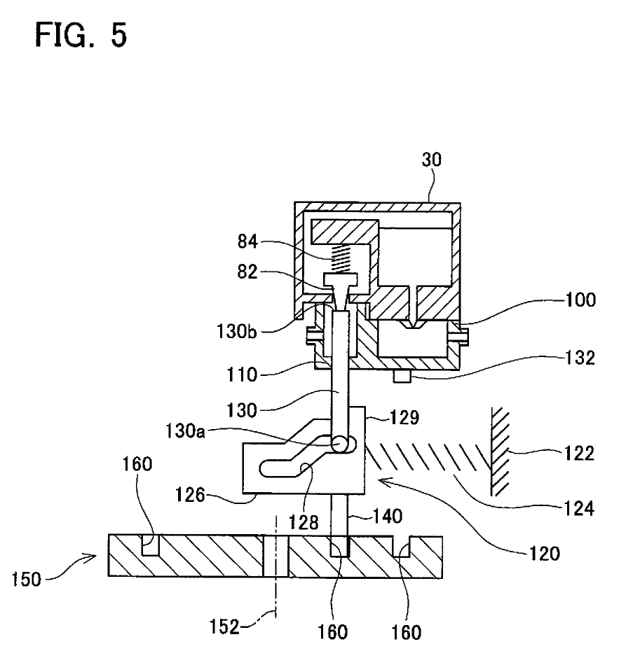

As described above, the slider 126 receives force from the spring 124 (force in the leftward direction of FIG. 3) such that the slider 126 approaches the rotation center 152 described later. The slider 126 is capable of moving from the position of FIG. 4 toward the rotation center 152 described later (leftward in FIG. 4) in accordance with the state of the cam member 150 described later. FIG. 5 shows the slider 126 having moved from the position of FIG. 4 toward the rotation center 152 described later (leftward in FIG. 4). That is, the slider 126 is capable of moving between a right position (the position of FIG. 4) and a left position (the position of FIG. 5).

In a state where the ink jet head 30 is present in the waiting position P1, the shaft 130 is present in a position corresponding to the exhaust opening 80 and the exhaust valve 82. That is, from a plan view of the ink jet printer 2, the shaft 130 overlaps with the exhaust opening 80 and the exhaust valve 82. The shaft 130 extends in a vertical direction. The shaft 130 is coupled to the slider 126. More specifically, the lower end 130a of the shaft 130 fits into the guide groove 128. In the case where the slider 126 moves in the horizontal direction, the shaft 130 is guided along the guide groove 128. Moreover, even if the slider 126 moves in the horizontal direction, the absolute position of the shaft 130 in the horizontal direction does not change. In a state where the slider 126 is present in the right position (the position of FIG. 4), the lower end 130a of the shaft 130 is present at the left end (the lower end) of the guide groove 128. In a state where the slider 126 is present in the left position (the position of FIG. 5), the lower end 130a of the shaft 130 is present at the right end (the upper end) of the guide groove 128.

An opening 116 is formed in a lower surface of the exhaust cap 110. The shaft 130 passes through the opening 116. An upper end 130b of the shaft 130 is present in the space 112 within the exhaust cap 110. Moreover, the shaft 130 is not fixed to the exhaust cap 110. That is, even if the exhaust cap 110 moves in a vertical direction, the shaft 130 does not move with the exhaust cap 110.

The stopper 132 is fixed to a lower surface of the nozzle cap 100. In a state where the nozzle cap 100 is present in the lower position (the state of FIG. 3), the stopper 132 makes contact with a side (the left side in FIG. 3) of the protrusion 129 of the slider 126, the side being closer to the rotation center 152 described later. The stopper 132 makes contact with the protrusion 129 from a side that is closer to the rotation center 162 described later than the protrusion 129. By contrast, in a state where the nozzle cap 100 is present in the upper position (the state of FIG. 4), the stopper 132 does not make contact with the protrusion 129 of the slider 126. In this state, the stopper 132 allows the leftward movement of the slider 126 that is receiving force in a leftward direction from the spring 124. That is, in a state where the stopper 132 is present in the lower position (the state of FIG. 3), the protrusion 129 makes contact with the stopper 132, and consequently the slider 126 cannot move from the position of FIG. 3 toward the rotation center 152 described later (leftward in FIG. 3). In a state where the stopper 132 is present in the upper position (the state of FIG. 4), the slider 126 is capable of moving to the position of FIG. 5 toward the rotation center 152 described later (leftward in FIG. 4) in accordance with the state of the cam member 150 described later.

### (Configuration Relating to Cam)

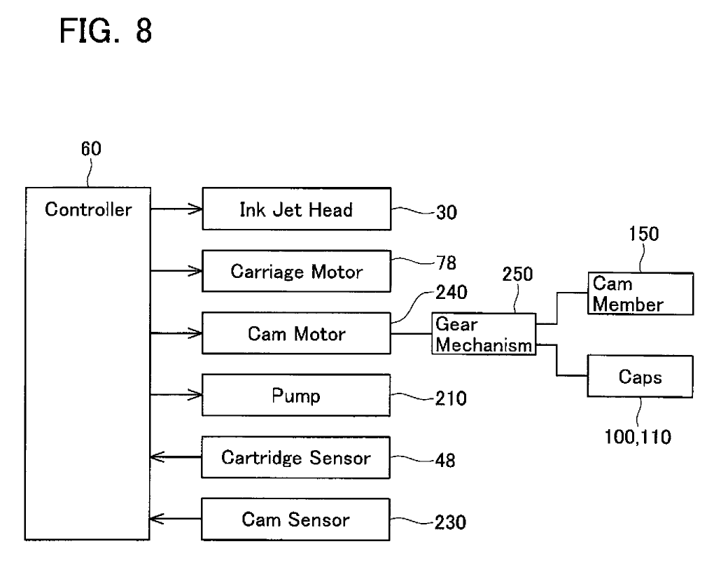

The ink jet printer 2 comprises a cam follower 140, the cam member 150, and a cam motor 240 (see FIG. 8). The cam follower 140 extends in a vertical direction. One end of the cam follower 140 is fixed to a lower surface of the slider 126. The other end of the cam follower 140 is coupled to the cam member 150. More specifically, the other end of the cam follower 140 fits into a cam groove 160 formed in the cam member 150. In the case where the cam member 150 rotates, the cam follower 140 is guided along the cam groove 160.

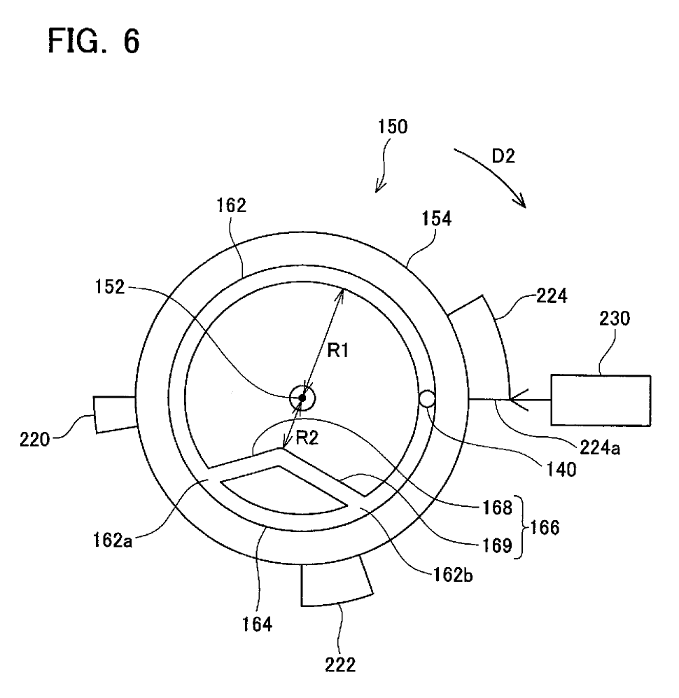

The cam member 150 is connected to the cam motor 240 (see FIG. 8). The cam member 150 has a rotation axis 152 as its center, and is capable of rotating. FIG. 6 shows a plan view of the cam member 150 (a view along the direction of the arrow D1 in FIG. 3). The cam member 150 is capable of rotating in the direction of the arrow D2 (clockwise). Moreover, in the present embodiment, the cam member 150 does not rotate in the anti-clockwise direction. The cam member 150 comprises a cam main body 154 and three protruding parts 220, 222, and 224. The cam main body 154 is substantially disc shaped. The cam groove 160 is formed in an upper surface of the cam main body 154 (a surface at the upper side in FIG. 3). The cam groove 160 is a cross-sectionally U-shaped groove that comprises a guide surface for guiding the cam follower 140.

The cam groove 160 comprises a first groove 162, a second groove 164, and a third groove 166. The first groove 162 has an arc shape with the rotation center 152 of the cam member 150 as its center. The first groove 162 extends clockwise from one end 162a to the other end 162b. The second groove 164 and the third groove 166 branch from the one end 162a of the first groove 162. Further, the second groove 164 and the third groove 166 branch from the other end 162b of the first groove 162. The second groove 164 has an arc shape with the rotation center 152 of the cam member 150 as its center. The second groove 164 extends in an anti-clockwise direction from the one end 162a of the first groove 162 to the other end 162b of the first groove 162. The first groove 162 and the second groove 164 form a circular loop. The third groove 166 comprises a linear shaped groove 168 extending from the one end 162a of the first groove 162 to an inner circumferential side and a linear shaped groove 169 extending from the other end 162b of the first groove 162 to the inner circumferential side. An end part at an innermost circumferential side of the groove 168 and an end part at an innermost circumferential side of the groove 169 are connected. Moreover, below, the position where the groove 168 and the groove 169 are connected is termed an intermediate position.

As described above, the first groove 162 and the second groove 164 form a circular loop. Further, the third groove 166 extends towards the inner circumferential side from the one end 162a and the other end 162b of the first groove 162. As a result, a distance R2 between the rotation center 152 and the third groove 166 is smaller than a distance R1 between the rotation center 152 and the first groove 162 (that is, the distance R1 between the rotation center 152 and the second groove 164). The distance between the rotation center 152 and any position in the third groove 166 is smaller than the distance R1.

When the cam member 150 rotates in the direction of the arrow D2, the cam follower 140 is guided along the cam groove 160. That is, there is a change in the relative position of the cam follower 140 with respect to the cam groove 160. In the present embodiment, the second groove 164 and the third groove 166 branch from the one end 162a of the first groove 162. As a result, a state in which the cam follower 140 is guided along the first groove 162 and the second groove 164 and also a state in which the cam follower 140 is guided along the first groove 162 and the third groove 166 exist. This feature will be described later in detail.

The three protruding parts 220, 222 and 224 are fixed to an outer circumferential face (a side face) of the cam main body 154. Along the circumferential direction of the cam main body 154, the protruding part 220 has the shortest length, the protruding part 222 has a medium length and the protruding part 224 has the longest length.

The ink jet printer 2 further comprises a cam sensor 230. The cam sensor 230 is disposed in the vicinity of the cam member 150. The cam sensor 230 is connected to the controller 60 (see FIG. 8). In a state where the cam sensor 230 is facing the protruding parts 220, 222 and 224, a first signal (for example, a high signal) is sent to the controller 60. In a state where the cam sensor 230 is not facing the protruding parts 220, 222 and 224, a second signal (for example, a low signal) is sent to the controller 60. As described above, the protruding parts 220, 222 and 224 have differing lengths. As a result, in the case where the cam member 150 rotates at the constant speed, the periods during which the cam sensor 230 is facing the protruding parts 220, 222 and 224 respectively differ. For example, the period for which the cam sensor 230 is facing the protruding part 220 is short, while the period for which the cam sensor 230 is facing the protruding part 224 is long. As a result, the period at which the cam sensor 230 begins and finishes sending the first signal (hereinbelow termed a period of the first signal) changes in accordance with which of the protruding parts 220, 222 and 224 is facing the cam sensor 230.

### (Configuration of Rotation Member)

As shown in FIG. 3, the ink jet printer 2 further comprises the rotation member 170. FIG. 7 shows a plan view of the rotation member 170 (a view in the direction of the arrow D1 of FIG. 3). The rotation member 170 comprises a main body member 172 and a ring member 174. The main body member 172 is substantially disc shaped. As shown in FIG. 3, the main body member 172 is coupled to the cam member 150 below this cam member 150. As a result, the main body member 172 rotates following the rotation of the cam member 150. The main body member 172 also rotates in the direction of the arrow D2 (clockwise) of FIG. 6. The gas passage 172a is formed within the main body member 172. One end 172b and the other end 172c of the gas passage 172a open onto an outer circumferential face (a side face) of the main body member 172.

The ring member 174 has a ring shape. The main body member 172 is fitted into the interior of the ring member 174. The ring member 174 is fixed to the side of the casing 4 (see FIG. 1), and does not rotate. Three through holes 174a, 174b and 174c are formed in the ring member 174. The through hole 174a communicates with the first passage 180. That is, as shown in FIG. 3, the through hole 174a communicates with the space 102 within the nozzle cap 100 via the first passage 180. The through hole 174b communicates with a pump passage 200. The ink jet printer 2 further comprises a pump 210. The pump passage 200 is connected to the pump 210. The through hole 174c communicates with the second passage 190. That is, as shown in FIG. 3, the through hole 174c communicates with the space 112 within the exhaust cap 110 via the second passage 190.

When the cam member 150 rotates, the main body member 172 rotates with respect to the ring member 174. In accordance with the phase of the cam member 150 (the phase of the main body member 172), the gas passage 172a of the main body member 172 assumes a communicating state with the through holes 174a, 174b, and 174c of the ring member 174. For example, when the main body member 172 rotates clockwise by 180 degrees from the state of FIG. 7, the one end 172b of the gas passage 172a communicates with the through hole 174a, and the other end 172c of the gas passage 172a communicates with the through hole 174b. In this state, the space 102 within the nozzle cap 100 communicates with the pump 210 via the first passage 180, the through hole 174a, the gas passage 172a, the through hole 174b, and the pump passage 200. Further, for example, when the main body member 172 rotates clockwise by 270 degrees from the state of FIG. 7, the one end 172b of the gas passage 172a communicates with the through hole 174b, and the other end 172c of the gas passage 172a communicates with the through hole 174c. In this state, the space 112 within the exhaust cap 110 communicates with the pump 210 via the second passage 190, the through hole 174c, the gas passage 172a, the through hole 174b, and the pump passage 200.

### (Control Configuration)

Next, the control configuration of the ink jet printer 2 will be described. Moreover, a brief description will also be given herein of the configuration for moving the nozzle cap 100 and the exhaust cap 110 (see FIG. 3) in the vertical direction (which may also be referred to as the configuration for moving the stopper 132 in the vertical direction). FIG. 8 shows a schematic view of the control configuration of the ink jet printer 2. The controller 60 sends control signals to the ink jet head 30 (see FIG. 1), the carriage motor 78 (see FIG. 2), the cam motor 240, and the pump 210 (see FIG. 3 and FIG. 7). The elements 30, 78, 240 and 210 are thereby controlled. Further, the cartridge sensor 48 (see FIG. 1) and the cam sensor 230 (see FIG. 6) send the first signal (e.g., the high signal) and the second signal (e.g., the low signal) to the controller 60. The controller 60 is capable of detecting whether the ink cartridge 50 is housed in the cartridge housing part 46 based on the signals from the cartridge sensor 48. Further, the controller 60 is capable of detecting the phase of the cam member 150 based on the signals from the cam sensor 230.

Moreover, the ink jet printer 2 further comprises a gear mechanism 250 connected to the cam motor 240. The cam member 150 and the caps 100 and 110 are connected to the cam motor 240 via the gear mechanism 250. When the cam motor 240 rotates in a positive direction, the gear mechanism 250 transmits the driving force of the cam motor 240 to the caps 100 and 110. In this case, the driving force of the cam motor 240 is not transmitted to the cam member 150. When the cam motor 240 rotates in the positive direction, the caps 100 and 110 move in the vertical direction. For example, in a state where the caps 100 and 110 are present in the lower position (the state of FIG. 3), the caps 100 and 110 move to the upper position (the state of FIG. 4) when the cam motor 240 rotates by a first angle in the positive direction. Further, for example, in a state where the caps 100 and 110 are present in the upper position in (the state of FIG. 4), the caps 100 and 110 move to the lower position (the state of FIG. 3) when the cam motor 240 rotates by a second angle in the positive direction. By contrast, when the cam motor 240 rotates in a reversed direction, the gear mechanism 250 transmits the driving force of the cam motor 240 to the cam member 150. In this case, the driving force of the cam motor 240 is not transmitted to the caps 100 and 110. Moreover, this type of method for changing the object to which the driving force is transmitted in accordance with the direction of rotation of the motor is taught in, for example, U.S. Pat. No. 6,883,896. The contents of this document are incorporated by reference into the present specification.

### (Operation of the Other Elements Accompanying the Rotation of the Cam Member)

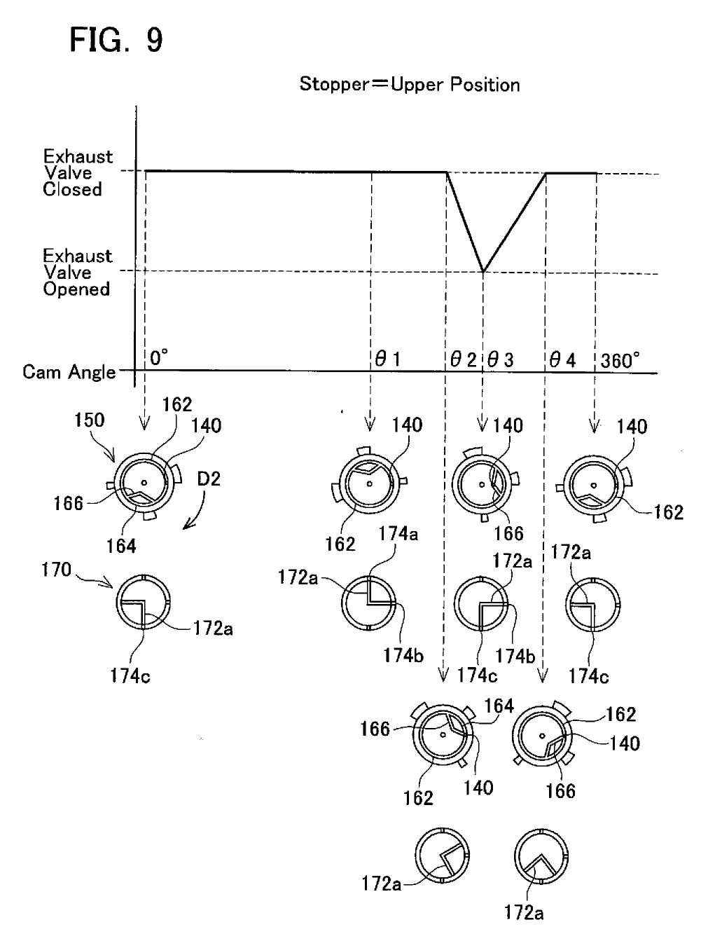

Next, the operation of the other elements accompanying the rotation of the cam member 150 will be described. First, with reference to FIG. 9, the case in which the cam member 150 rotates in a state where the stopper 132 is present in the upper position (the position of FIG. 4 and FIG. 5) will be described. In the present embodiment, in a state where the cam member 150 is present in the phase shown in FIG. 6, the phase of the cam member 150 is zero. Moreover, the state shown in FIG. 6 is a state in which a downstream end surface 224a, in the direction of rotation, of the longest protruding part 224 of the cam member 150 is facing the cam sensor 230 (a state of having being detected by the cam sensor 240). The state of the phase of the cam member 150 being zero can be termed, in other words, an initial position of the cam member 150.

In the state where the phase of the cam member 150 is zero, the cam follower 140 is present in the first groove 162, the slider 126 is present in the right position (the position of FIG. 4), and the lower end 130a of the shaft 130 is present in the lower end (the left end) of the guide groove 128 of the slider 126. In this state, the upper end 130b of the shaft 130 does not make contact with the exhaust valve 82, and the exhaust valve 82 is in the closed state. Further, in the state where the phase of the cam member 150 is zero, the gas passage 172a within the rotation member 170 communicates only with the through hole 174c of the ring member 174.

When the cam member 150 rotates in the direction of the arrow D2 (clockwise) from the state where the phase is zero to a state where the phase is θ1, the cam follower 140 is guided along the first groove 162. The cam follower 140 is still present within the first groove 162. As a result, the slider 126 is present in the right position (the position of FIG. 4), and the lower end 130a of the shaft 130 is present in the lower end (the left end) of the guide groove 128 of the slider 126. The exhaust valve 82 is still in the closed state. In the state where the phase of the cam member 150 is θ1, the gas passage 172a within the rotation member 170 communicates with the through hole 174a and the through hole 174b of the ring member 174. That is, the space 102 within the nozzle cap 100 communicates with the pump 210 via the gas passage 172a. Since the nozzle cap 100 is present in the upper position, the space 102 within the nozzle cap 100 is in a sealed state. In this state, if the pump 210 is driven, negative pressure is applied to the space 102 within the nozzle cap 100. As a result, ink is discharged from the nozzles 42. That is, a purge process can be executed.

When the cam member 150 rotates in the direction of the arrow D2 from the state where the phase is θ1 to a state where the phase is θ2, the cam follower 140 is guided along the first groove 162. The cam follower 140 reaches the one end 162a of the first groove 162. Since the stopper 132 is present in the upper position, the protrusion 129 does not make contact with the stopper 132 in the slider 126 that is receiving force from the spring 124 toward the rotation center 152 (leftward in FIG. 4). That is, the slider 126 is allowed to move toward the rotation center 152 of the cam member 150. As a result, when the cam member 150 rotates further in the direction of the arrow D2 from the state where the phase is θ2, the cam follower 140 is guided along the third groove 166 (more specifically the groove 168 (see FIG. 6)) that extends from the one end 162a of the first groove 162 toward the rotation center 152 of the cam member 150 and, as a result, the slider 126 also moves toward the rotation center 152 of the cam member 150 (leftward in FIG. 4).

When the slider 126 moves toward the rotation center 152 (leftward in FIG. 4), the lower end 130a of the shaft 130 is guided upward along the guide groove 128 of the slider 126. The shaft 130 thereby moves from the lower position (the position of FIG. 4) to the upper position (the position of FIG. 5). When the phase of the cam member 150 becomes θ3, the lower end 130a of the shaft 130 reaches the right end of the guide groove 128 of the slider 126, and the shaft 130 reaches the upper position (the position of FIG. 5). In this state, the upper end 130b of the shaft 130 makes contact with the exhaust valve 82, and since the upper end 130b of the shaft 130 pushes the exhaust valve 82 upwards, the exhaust valve 82 assumes the opened state. Moreover, in the state where the phase of the cam member 150 is θ3, the cam follower 140 is present in the intermediate position of the third groove 166 (the position closest to the rotation center 152 of the cam member 150).

In the state where the phase of the cam member 150 is θ3, the gas passage 172a within the rotation member 170 communicates with the through hole 174b and the through hole 174c of the ring member 174. That is, the space 112 within the exhaust cap 110 communicates with the pump 210 via the gas passage 172a. Since the exhaust cap 110 is present in the upper position, the space 112 within the exhaust cap 110 is in a sealed state. In this state, when the pump 210 is driven, negative pressure is applied to the space 112 within the exhaust cap 110. As a result, gas (air, etc.) within the ink chamber 32 is discharged via the exhaust passage 34 and the exhaust opening 80. That is, an exhaust process can be executed. If gas is present within the ink chamber 32, it is possible that this gas blocks the ink passage 36 (see FIG. 1), leading to unsatisfactory printing because ink cannot be discharged from the ink passage 36. In the present embodiment, since the exhaust process can be executed, such unsatisfactory printing can be restricted.

When the cam member 150 rotates in the direction of the arrow D2 from the state where the phase is θ3 to a state where the phase is θ4, the cam follower 140 is guided along the third groove 166 from the intermediate position of the third groove 166 (more specifically, is guided along the groove 169 (see FIG. 6)). That is, the cam follower 140 is guided away from the rotation center 152 of the cam member 150 and, as a result, the slider 126 also moves away from the rotation center 152 of the cam member 150 (the rightward direction of FIG. 5). The cam follower 140 reaches the other end 162b of the first groove 162. When the slider 126 moves in the rightward direction of FIG. 5, the lower end 130a of the shaft 130 is guided downward along the guide groove 128 of the slider 126. The shaft 130 thereby moves from the upper position (the position of FIG. 5) to the lower position (the position of FIG. 4). When the phase of the cam member 150 becomes θ4, the shaft 130 reaches the left end (the lower end) of the guide groove 128 of the slider 126, and reaches the lower position (the position of FIG. 4).

When the cam member 150 rotates further in the direction of the arrow D2 from the state where the phase is θ4, the cam member 150 returns to the initial position in which the phase is zero. As is clear from the above description, in the state where the stopper 132 is present in the upper position (the position of FIG. 4), the cam follower 140 is guided along the first groove 162 and the third groove 166, and is not guided along the second groove 164. In the state where the cam follower 140 is present in the first groove 162, the exhaust valve 82 is in the closed state, and in the state where the cam follower 140 is present in the intermediate position of the third groove 166, the exhaust valve 82 is in the closed state. The exhaust valve 82 can be switched between the closed state and the opened state by performing one revolution of the cam member 150.

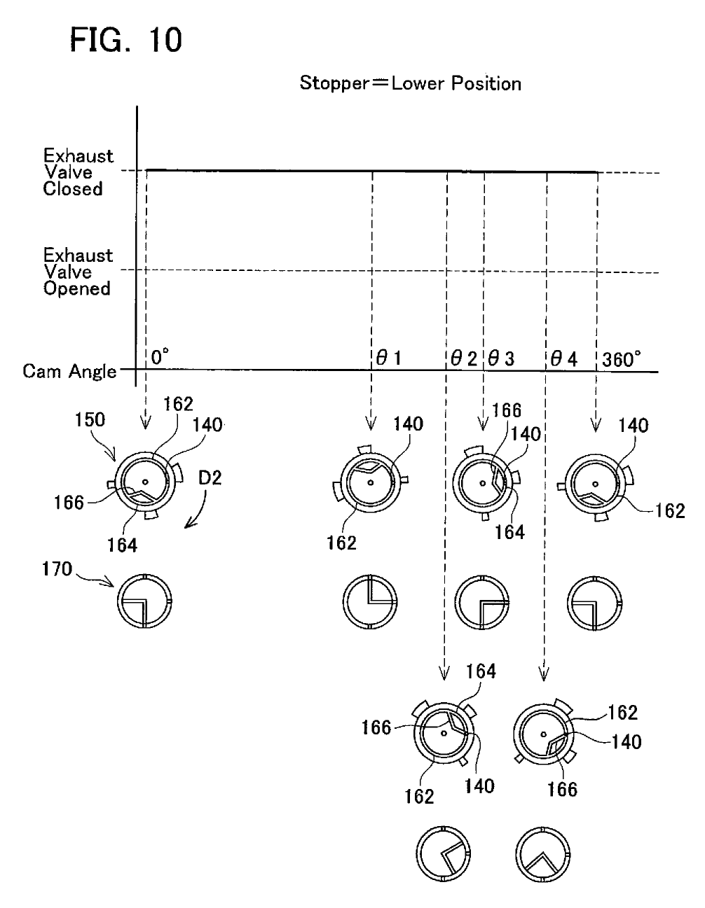

Next, with reference to FIG. 10, the case in which the cam member 150 rotates in the state where the stopper 132 is present in the lower position (the position of FIG. 3) will be described. The case in which the cam member 150 rotates in the direction of the arrow D2 from the state where the phase is zero to the state where the phase is θ2 is the same as in the case of FIG. 9. Since the stopper 132 is present in the lower position (the position of FIG. 3), the stopper 132 makes contact with the protrusion 129 from the side closer to the rotation center 152. As a result, the slider 126 cannot move in the leftward direction of FIG. 3 even if the slider 126 receives force from the spring 124 to move the slider 126 toward the rotation center 152 (force in the leftward direction of FIG. 3). As a result, when the cam member 150 rotates further in the direction of the arrow D2 from the state where the phase is θ2, the cam follower 140 is guided along the second groove 164. In this case, since the slider 126 does not move, the exhaust valve 82 maintains the closed state without the shaft 130 also moving upward.

When the cam member 150 rotates in the direction of the arrow D2 from the state where the phase is θ2 to the state where the phase is θ4, the cam follower 140 reaches the other end 162b of the first groove 162. When the cam member 150 rotates further in the direction of the arrow D2 from the state where the phase is θ4, the cam member 150 returns to the initial position where the phase is zero. As is clear from the above description, in the state where the stopper 132 is present in the lower position (the position of FIG. 3), the cam follower 140 is guided along the first groove 162 and the second groove 164, and is not guided along the third groove 166. The exhaust valve 82 is in the closed state regardless of whether the cam follower 140 is present in either the first groove 162 or the second groove 164. As a result, the exhaust valve 82 can maintain the closed state even if the cam member 150 undergoes one revolution. Utilizing this, the ink jet printer 2 executes a process (described later) for returning to an original position that stops the cam member 150 in the initial position.

### (Processes Executed by Controller)

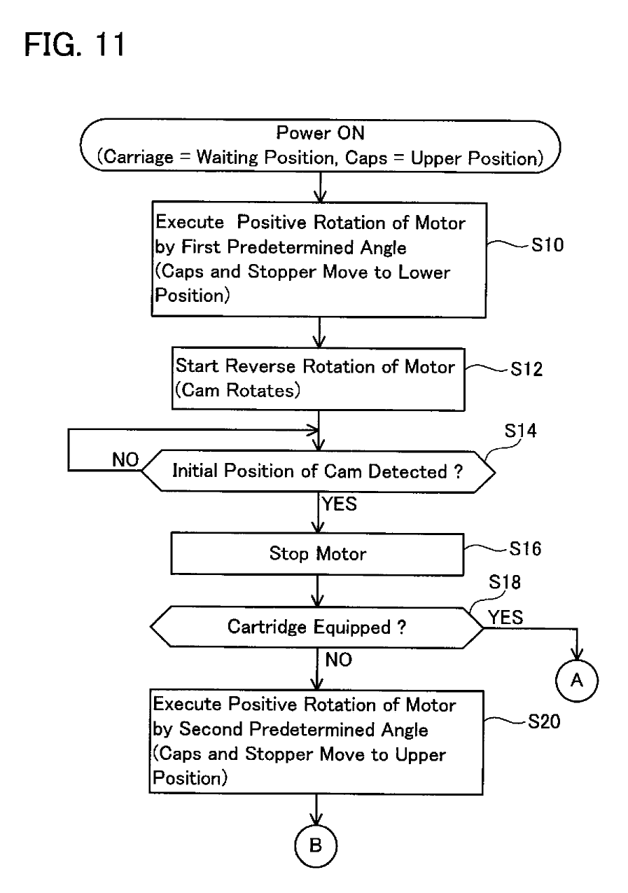

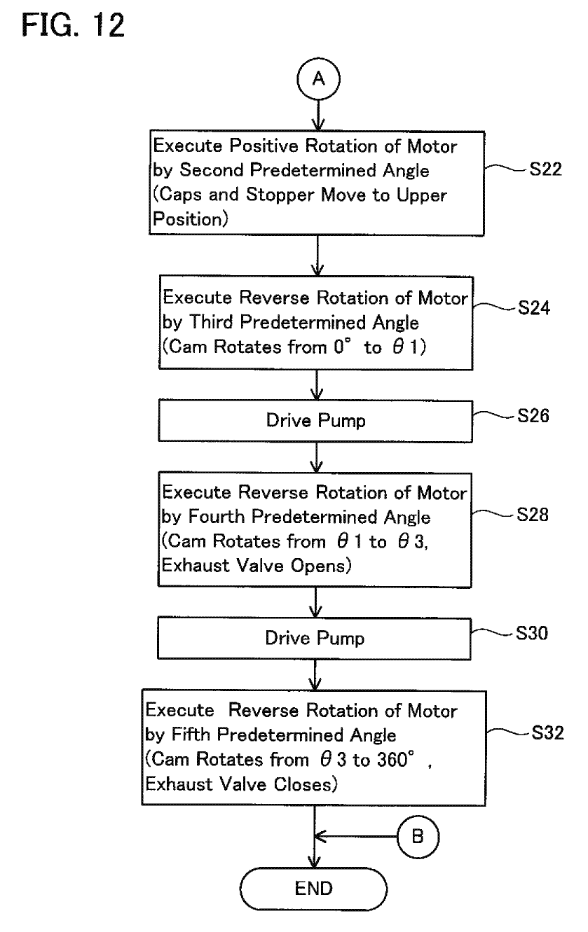

Next, processes executed by the controller 60 will be described. FIG. 11 and FIG. 12 show a flowchart of the processes executed by the controller 60. In an initial state in which the ink jet printer 2 is manufactured and shipped, the carriage 70 is present in the waiting position P1 (see FIG. 2), and the caps 100 and 110 are present in the upper position (the position of FIG. 4). Turning on a power source of the ink jet printer 2 in this initial state is a trigger for starting the flowchart of FIG. 11 and FIG. 12.

The controller 60 executes positive rotation of the cam motor 240 (see FIG. 8) by a first predetermined angle (S10). The caps 100 and 110 thereby move from the upper position (the position of FIG. 4) to the lower position (the position of FIG. 3). The stopper 132 that is fixed to the nozzle cap 100 also moves from the upper position to the lower position. The slider 126 is thereby prevented from moving in the leftward direction of FIG. 3.

Next, the controller 60 starts reverse rotation of the cam motor 240 (S12). The cam member 150 starts to rotate in the direction of D2 of FIG. 6. Since the stopper 132 is present in the lower position (the position of FIG. 3), the cam follower 140 is guided along the first groove 162 and the second groove 164, and is not guided along the third groove 166, even if the cam member 150 rotates. As a result, the exhaust valve 82 is maintained in the closed state (see FIG. 10).

In the state where the cam member 150 is rotating, the controller 60 monitors a signal sent from the cam sensor 230 (see FIG. 6) (S14). As described above, in the process of the cam member 150 performing one revolution, there is a change in the period that the cam sensor 230 sends the first signal (e.g., the high signal) to the controller 60. In S14, the controller 60 first carries out at least one revolution of the cam member 150, and monitors the change in the period of the first signal across three stages. Since the protruding parts 220, 222 and 224 face the cam sensor 230 in sequence, the period of the first signal changes in sequence from a shortest state, to a medium state and then to a longest state. The controller 60 further rotates the cam member 150. The controller 60 detects in sequence that the period of the first signal is in the shortest state and the medium state, and then determines YES in S14 when there is a change from the second signal to the first signal (that is, when the starting point of the longest period of the first signal is detected). The timing at which YES is determined in S14 is the timing at which the cam sensor 230 is facing the surface 224a of the protruding part 224 (see FIG. 6). In the case of YES in S14, the controller 60 stops the cam motor 240 (S16). The cam member 150 thereby stops in the initial position (the position of FIG. 6). That is, the process for returning the cam member 150 to the original position is completed.

If the process for returning the cam member 150 to the original position is executed, it is possible to stop the cam member 150 in the initial position (the state where the phase is zero). In the case where the cam member 150 is present in the initial position, when the cam member 150 is rotated in a later process, the cam member 150 can be stopped in a desired phase by adjusting the angle of rotation of the cam motor 240 (for example, see a third predetermined angle of S24, a fourth predetermined angle of S28 and a fifth predetermined angle of S32, all of FIG. 11). For example, even in the case where the cam member 150 cannot be stopped in a desired phase based on the signal sent from the cam sensor 230 (the case where it is desirable to stop the cam member 150 in a phase in which the protruding parts 220, 222 and 224 are not facing the cam sensor 230), it is possible to stop the cam member 150 in the desired phase based on the angle of rotation of the cam motor 240.

Moreover, if the cam member 150 is adjusted to the initial position in the initial state in which the ink jet printer 2 is manufactured and shipped, it is unlikely that the process for returning the cam member 150 to the original position will be required. However, there is a possibility that external force will be applied to the cam member 150 during the transportation of the ink jet printer 2, and that the cam member 150 consequently may rotate. That is, there is a possibility that the cam member 150 becomes misaligned from the initial position even though the cam member 150 had been adjusted to the initial position. In the present embodiment, in order to resolve this type of problem, the process for returning the cam member 150 to the original position is executed in the process of FIG. 11 when the power source is turned on for the first time after manufacturing and shipping. Further, as will be described later, the process for returning the cam member 150 to the original position is executed in cases where other conditions are fulfilled. This is because it is not possible to eliminate the possibility of the cam member 150 becoming misaligned from the initial position during the utilization of the ink jet printer 2.

Next, the controller 60 confirms the state of the signal sent from the cartridge sensor 48 (see FIG. 1) (S18). As described above, in a state where the ink cartridge 50 is present in the cartridge housing part 46, the cartridge sensor 48 sends the first signal (e.g., the high signal). In the case where the first signal sent from the cartridge sensor 48 has been received, the controller 60 determines YES in S18. In this case, the process proceeds to S22 of FIG. 12.

By contrast, in the case where the second signal sent from the cartridge sensor 48 has been received, the controller 60 determines NO in S18. In this case, the controller 60 executes positive rotation of the cam motor 240 (see FIG. 8) by a second predetermined angle (S20). The caps 100 and 110 thereby move from the lower position (the position of FIG. 3) to the upper position (the position of FIG. 4). When S20 ends, the controller 60 ends the process of FIG. 11 and FIG. 12, and shifts into the waiting state.

In S22 of FIG. 12, the controller 60 executes a positive rotation of the cam motor 240 by the second predetermined angle. The process of S22 is the same as the process of S20 of FIG. 11. The caps 100 and 110 thereby move from the lower position (the position of FIG. 3) to the upper position (the position of FIG. 4). Further, the stopper 132 fixed to the nozzle cap 100 also moves from the lower position to the upper position.

Next, the controller 60 executes reverse rotation of the cam motor 240 by a third predetermined angle (S24). The cam member 150 is thereby rotated from the initial position in which the phase is zero to the state where the phase is θ1 (see FIG. 9). As described above, in the state where the phase of the cam member 150 is θ1, the space 102 within the nozzle cap 100 communicates with the pump 210 via the gas passage 172a. Next, the controller 60 drives the pump 210 (S26). Ink is thereby discharged from the nozzles 42. The purge process is thereby completed.

Next, the controller 60 executes reverse rotation of the cam motor 240 by a fourth predetermined angle (S28). The cam member 150 is thereby rotated from the state where the phase is θ1 to the state where the phase is θ3 (see FIG. 9). As described above, in the state where the phase of the cam member 150 is θ3, the space 112 within the exhaust cap 110 communicates with the pump 210 via the gas passage 172a. Moreover, the exhaust valve 82 is in the opened state. Next, the controller 60 drives the pump 210 (S30). Gas within the ink chamber 32 is thereby discharged via the exhaust passage 34 and the exhaust opening 80. The exhaust process is thereby completed. When the exhaust process is completed, the interior of the ink chamber 32 is filled with ink.

Finally, the controller 60 executes reverse rotation of the cam motor 240 by a fifth predetermined angle (S32). The cam member 150 is thereby rotated from the state where the phase is θ3 to a state where the phase is 360 degrees (that is, the initial position). The exhaust valve 82 assumes the closed state during this process. When S32 ends, the process of FIG. 11 and FIG. 12 ends.

In the ink jet printer 2 of the aforementioned embodiment, the cam member 150 comprises the second groove 164 and the third groove 166 that branch from the first groove 162. In the state where the cam follower 140 is present in the first groove 162 or the second groove 164, the exhaust valve 82 is maintained in the closed state. Further, in the state where the cam follower 140 is present in the intermediate position of the third groove 166 (the position where the phase of the cam member 150 is θ3), the exhaust valve 82 assumes the opened state. The cam follower 140 can be switched between the state of being guided along the third groove 166 and the state of being guided along the second groove 164 by adjusting the position of the stopper 132. In the former state, the exhaust valve 82 can be in the opened state, and consequently it is possible to execute the exhaust process in which gas within the ink chamber 32 is discharged. Further, in the latter state, it is possible to rotate the cam member 150 while the exhaust valve 82 is maintained in the closed state. The process for returning the cam member 150 to the original position can thereby be executed without opening the exhaust valve 82 (see S14 and S16 of FIG. 11). It is possible to control the opening of the exhaust valve 82 in situations other than situations in which the exhaust process must be executed.

If a configuration is adopted in which the third groove 166 is not present and the exhaust valve 82 is opened when the process for returning the cam member 150 to the original position is executed (below, this is termed a specific configuration), the following problems occur. When the process for returning the cam member 150 to the original position is executed, air may enter the ink chamber 32 from the exhaust valve 82 since the exhaust valve 82 is open, and unsatisfactory printing may occur. Unsatisfactory printing caused by the presence of air in the ink chamber 32 might be rectified by executing the exhaust process. For example, in the processes of FIG. 11 and FIG. 12, the exhaust process is executed after the process for returning the cam member 150 to the original position, and consequently unsatisfactory printing might not occur even if the exhaust valve 82 is opened when the process for returning the cam member 150 to the original position is executed. However, the process for returning the cam member to the original position is not executed only during the processes of FIG. 11 and FIG. 12, but is also executed when other conditions have been fulfilled. For example, the process for returning the cam member 150 to the original position may be executed after a predetermined period has elapsed since the previous execution of the process for returning the cam member, or may be executed when the user executes a predetermined operation. Further, the process for returning the cam member 150 to the original position may be executed whenever, for example, the purge process (the process of S26 of FIG. 12) has been executed a predetermined number of times. That is, there are situations in which only the process for returning the cam member 150 to the original position needs to be executed, while it is not necessary to execute the exhaust process. In the ink jet printer 2 of the present embodiment, the process for returning the cam member to the original position can be executed without opening the exhaust valve 82, and consequently, the exhaust process after the process for returning the cam member to the original position does not necessarily need to be executed. The exhaust process after the process for returning the cam member to the original position can be omitted. As a result, compared to the aforementioned specific configuration in which the exhaust process is required after the process for returning the cam member to the original position, it is possible to reduce the time required to execute the processes for returning the cam member to the original position. Moreover, this description does not exclude a configuration in which the exhaust process is executed after the process for returning the cam member to the original position. The exhaust process after the process for returning the cam member to the original position may be executed as required (see, for example, the flowchart of FIG. 11 and FIG. 12).

Moreover, even in the aforementioned specific configuration, the process for returning the cam member to the original position can be executed without opening the exhaust valve 82 if the process for returning the cam member 150 to the original position is executed after the carriage 70 has been moved from the waiting position P1 to another position (for example, the printing position P2). However, in this method, the process of moving the carriage 70 from the waiting position P1 to another position is required when the process for returning the cam member to the original position is to be executed. As a result, there is an increase in the time required to execute the processes for returning the cam member to the original position. In the ink jet printer 2 of the present embodiment, the process for returning the cam member to the original position can be executed without opening the exhaust valve 82 in the state where the carriage 70 is present in the waiting position P1 (that is, in the state where the shaft 130 is present in a position facing the exhaust valve 82). Since the process of moving the carriage 70 is not necessary when the process for returning the cam member to the original position is to be executed, the time required to execute the processes for returning the cam member to the original position can be made shorter than in the method described above.

Further, in the present embodiment, the gas passage 172a is formed in the rotation member 170 that rotates following the rotation of the cam member 150. It is possible, by adjusting the phase of the cam member 150, to switch between a state where the space 102 within the nozzle cap 100 communicates with the pump 210 via the gas passage 172a, and a state where the space 112 within the exhaust cap 110 communicates with the pump 210 via the gas passage 172a. As a result, the purge process and the exhaust process can be executed independently by the single pump 210.

Variants of the above embodiment are set forth below.

(1) The other end 162b of the first groove 162 need not communicate with the second groove 164 and the third groove 166. For example, the first groove 162 and the second groove 164 need not form a circular loop, and instead an arc shape may be formed by the first groove 162 and the second groove 164. In this case, it is preferred that the cam member 150 is configured so as to be capable of rotating in both a clockwise and an anti-clockwise direction. Moreover, the cam groove 160 may further comprise the other groove. The other groove may communicate with at least one of the first groove 162, the second groove 164, and the third groove 166, or may equally well not communicate with any of the grooves 162, 164, and 166.

(2) In the above embodiments, the exhaust valve 82 is opened and closed by the exhaust valve 82 moving in the vertical direction. However, the exhaust valve 82 may equally well move in another direction (for example, the horizontal direction). In this case, it is preferred that the direction of movement of the configurational elements 84, 120, 140, 150, etc. is adjusted so that movement of the exhaust valve 82 in the other direction is realized.

(3) The stopper 132 may equally well not be fixed to the nozzle cap 100. For example, the stopper 132 may move its posture (position). In a state where the stopper 132 is in a first posture (first position), the stopper 132 may allow the slider 126 to move leftward in FIG. 3. In a state where the stopper 132 is in a second posture (second position), the stopper 132 may prevent the slider 126 from moving leftward in FIG. 3.

(4) The motor that rotates the cam member 150 may be a different motor from the motor that rotates the rotation member 170. Further, the motor that rotates the cam member 150 may be a different motor from the motor that moves the caps 100 and 110 in the vertical direction.

1. An ink jet printer, comprising:
an ink jet head comprising an ink chamber, an exhaust passage communicating with the ink chamber, and an exhaust valve disposed at the exhaust passage;
a cam member comprising a cam groove, the cam member configured to rotate, the cam groove comprising a first groove, a second groove, and a third groove, wherein the second groove and the third groove branch from one end of the first groove;
a cam follower configured to be guided along the cam groove in a case where the cam member rotates; and
a valve operation mechanism coupled to the cam follower,
wherein in a state where the cam follower is present at a predetermined position in the third groove, the valve operation mechanism makes contact with the exhaust valve, and the exhaust valve is in an opened state.

2. The ink jet printer as in claim 1, wherein
in a state where the cam follower is present in the first groove or the second groove, the valve operation mechanism does not make contact with the exhaust valve, and the exhaust valve is in a closed state.

3. The ink jet printer as in claim 1, wherein
the first groove and the second groove form a circular loop.

4. The ink jet printer as in claim 3, wherein
a distance between a rotation center of the cam member and the third groove is less than a distance between the rotation center of the cam member and the first groove or the second groove.

5. The ink jet printer as in claim 1, wherein
the second groove and the third groove further branch from the other end of the first groove.

6. The ink jet printer as in claim 1, wherein
the valve operation mechanism comprises a first member and a second member,
the first member is fixed to the cam follower,
the first member comprises a guide groove,
the second member is configured to be guided along the guide groove,
in the state where the cam follower is present at the predetermined position in the third groove, the second member is present at a first position in the guide groove, the second member makes contact with the exhaust valve, and the exhaust valve is in the opened state, and
in a state where the cam follower is present in the first groove or the second groove, the second member is present at a second position in the guide groove, the second member does not make contact with the exhaust valve, and the exhaust valve is in the closed state.

7. The ink jet printer as in claim 6, wherein
the valve operation mechanism further comprises a spring configured to apply a force to the first member in a predetermined direction, and a movement member configured to move between a third position and a fourth position,
in a state where the movement member is present at the third position, the movement member allows the first member to move in the predetermined direction by the movement member being away from the first member,
in a state where the movement member is present at the fourth position, the movement member prohibits the first member from moving in the predetermined direction by the movement member making contact with the first member from a direction opposite to the direction in which the spring pushes the first member, and
the second member is guided from the second position to the first position by movement of the first member in the predetermined direction.

8. The ink jet printer as in claim 7, wherein
in a case where the cam member rotates in the state where the movement member is present at the third position, the cam follower is guided toward the third groove at the one end of the first groove and the first member moves in the predetermined direction, and
in a case where the cam member rotates in the state where the movement member is present at the fourth position, the cam follower is guided toward the second groove at the one end of the first groove and the first member does not move in the predetermined direction.

9. The ink jet printer as in claim 7, further comprising:
a first cap,
wherein the ink jet head further comprises a nozzle surface in which a nozzle communicating with the ink chamber is formed,
the first cap is configured to cap the nozzle surface,
the movement member is fixed to the first cap, and
the movement member moves between the third position and the fourth position by movement of the first cap.

10. The ink jet printer as in claim 9, further comprising:
a motor configured to rotate the cam member,
wherein the motor further rotates the first cap.

11. The ink jet printer as in claim 1, wherein
the valve operation mechanism comprises a movement member configured to move between a third position and a fourth position,
in a case where the cam member rotates in a state where the movement member is present at the third position, the cam follower is guided toward the third groove at the one end of the first groove, and
in a case where the cam member rotates in a state where the movement member is present at the fourth position, the cam follower is guided toward the second groove at the one end of the first groove.

12. The ink jet printer as in claim 1, further comprising:
a second cap configured to cap the exhaust valve;
a pump; and
a gas passage configured to allow a space within the second cap to communicate with the pump.

13. The ink jet printer as in claim 1, further comprising:
a first cap;
a second cap;
a pump; and
a rotation member configured to rotate following the rotation of the cam member,
wherein the ink jet head further comprises a nozzle surface in which a nozzle communicating with the ink chamber is formed,
the first cap is configured to cap the nozzle surface,
the second cap is configured to cap the exhaust valve,
the rotation member comprises a gas passage,
in a state where the cam member is present at a first phase within a phase range of one revolution, a space within the first cap communicates with the pump via the gas passage of the rotation member, and
in a state where the cam member is present at a second phase within the phase range, a space within the second cap communicates with the pump via the gas passage of the rotation member.

14. The ink jet printer as in claim 13, wherein
in the state where the cam member is present at the second phase, the cam follower is present at the predetermined position in the third groove.

15. The ink jet printer as in claim 1, further comprising:
a controller configured to control the rotation of the cam member,
wherein the controller executes an initialization process for stopping the cam member at a predetermined phase within a phase range of one revolution, and
in the initialization process, the cam follower is guided along the first groove and the second groove, and is not guided along the third groove.
